(19) United States
(12) Patent Application Publication
(10) Pub. No.: US 2019/0129366 A1
(43) Pub. Date: May 2, 2019

(54) OPERATIONAL CONTROL OPTIMIZATION

(71) Applicant: General Electric Company, Schenectady, NY (US)

(72) Inventors: Wesley Michael SKEFFINGTON, Ballston Lake, NY (US); Joel F. MARKHAM, Niskayuna, NY (US); Andrew William BERNER, Waterford, NY (US); Austars Raymond SCHNORE, JR., Scotia, NY (US)

(21) Appl. No.: 15/799,676

(22) Filed: Oct. 31, 2017

(51) Int. Cl. G05B 13/04

(52) U.S. Cl. CPC G05B 13/041

(57) ABSTRACT

According to some embodiments, system and methods are provided, comprising receiving an operational objective for one or more assets at an optimization module; generating, via the optimization module, one or more operational settings to apply to the one or more assets based on the received operational objective; receiving the one or more generated operational settings at a local controller for each of the one or more assets; and generating an operating response of the one or more assets to achieve the one or more generated operational settings. Numerous other aspects are provided.

### BACKGROUND

Industrial equipment or assets, generally, are engineered to perform particular tasks as part of industrial processes. For example, industrial assets can include, among other things and without limitation, manufacturing equipment on a production line, aircraft engines, wind turbines that generate electricity on a wind farm, power plants, locomotives, healthcare or imaging devices (e.g., X-ray or MRI systems) for use in patient care facilities, or drilling equipment for use in mining operations. The design and implementation of these assets often takes into account both the physics of the task at hand, as well as the environment in which such assets are configured to operate and the specific operating control these systems are assigned to.

Low-level software and hardware-based controllers have long been used to drive industrial assets. However, typically, operation of individual assets via these controllers is managed by human driven manual touchpoints that are time consuming and prone to error.

It would be desirable to provide systems and methods to improve operational control of an industrial asset(s).

### BRIEF DESCRIPTION

According to some embodiments, a computer-implemented method includes receiving an operational objective for one or more assets at an optimization module; generating, via the optimization module, one or more operational settings to apply to the one or more assets based on the received operational objective; receiving the one or more generated operational settings at a local controller for each of the one or more assets; and generating an operating response of the one or more assets to achieve the one or more generated operational settings.

According to some embodiments, a system includes one or more assets; a computer programmed with an optimization module for the asset, the optimization module for controlling operations of the one or more asset with respect to an operational objective; the computer including a processor and a memory in communication with the processor, the memory storing the optimization module and additional program instructions, wherein the processor is operative with the optimization module and additional program instructions to perform functions as follows: receiving the operational objective for one or more assets at the optimization module; generating, via the optimization module, one or more operational settings to apply to the one or more assets based on the received operational objective; receiving the one or more generated operational settings at a local controller for each of the one or more assets; and generating an operating response of the one or more assets to achieve the one or more generated operational settings.

According to some embodiments, a non-transitory, computer-readable medium storing instructions that, when executed by a computer processor, cause the computer processor to receive the operational objective for one or more assets at the optimization module; generate, via the optimization module, one or more operational settings to apply to the one or more assets based on the received operational objective; receive the one or more generated operational settings at a local controller for each of the one or more assets; and generate an operating response of the one or more assets to achieve the one or more generated operational settings.

A technical effect of some embodiments of the invention is an improved and/or computerized technique and system for operating one or more assets with respect to a particular objective. Embodiments provide for a scalable software platform that is able to implement control and optimization functions that adjust the operations of one or more assets based on an objective. Embodiments provide a system that may post information through an industrial internet connection, for example, allowing the aggregation of data, and for allowing the implementation of a secure hierarchy of control and optimization functions within the context of industrial internet connected control systems. Embodiments provide for the dynamic adjustment of a process, deployment configuration and computation based on connected data sources and control or optimization goals. Embodiments provide for automatic data transfers between control links of individual assets to a group of assets to a network of assets. Embodiments also provide for a global optimization versus a local optimization. For example, from an individual wind turbine's stand point, it may be desirable to produce as much energy as possible (local optimization), given the constraints of the asset, but from a higher-level stand point, it may be desirable to maximize the remaining life of the turbine (global optimization), and to achieve the global optimization, the turbine may not produce as much energy as possible. As another example, at a wind farm, the farm output may be maximized and not the individual wind turbine. Yet another example, in a rail network, a train may be operated to maximize the total network system speed, as opposed to maximizing the speed of the individual train. Still another example may be that of a power plant, where the plant may extract maximum power value based on fuel price, weather, electricity costs, as opposed to maximization of an average turbine value. With this and other advantages and features that will become hereinafter apparent, a more complete understanding of the nature of the invention can be obtained by referring to the following detailed description and to the drawings appended hereto.

Other embodiments are associated with systems and/or computer-readable medium storing instructions to perform any of the methods described herein.

### DRAWINGS

FIG. 1 illustrates a system diagram according to some embodiments.

FIG. 2 illustrates a system diagram according to some embodiments.

FIG. 3 illustrates a flow diagram of a system according to some embodiments.

FIG. 4 illustrates a table according to some embodiments.

FIG. 5 illustrates a block diagram according to some embodiments

FIG. 6 illustrates a block diagram according to some embodiments.

FIG. 7 illustrates a table according to some embodiments.

### DETAILED DESCRIPTION

Low-level software and hardware-based controllers have long been used to drive industrial assets. Often a networked system includes multiple industrial assets. Typical system level operations are managed by many human driven manual touchpoints that are labor-intensive and prone to error. Embodiments provide for automation and optimization of the networked system based on data available in the system under control or using adjacent external data sources that may provide insight on non-controlled influences on a networked system's operation.

Often it is desirable to optimize some aspect of the operation of the industrial asset. Conventional optimizers are typically very localized and specific for a particular aspect of an individual asset, as opposed to global optimization of a single asset and/or a system of assets. As a non-exhaustive example, suppose the industrial asset is a wind turbine at a windfarm, including hundreds of turbines. Each wind turbine may include a localized optimizer that suggests to the local turbine controller that the turbine operate to put out the most power that it can. However, the optimal state for the individual turbine may not be the optimal state when considered as part of the whole farm. Typically, the operations and management of the whole farm are human-driven.

One or more embodiments provide for the replacement of the human driven operations with an optimization module that includes a macro controller to automatically control the low-level controllers at the individual assets to perform their tasks to achieve a particular goal or objective. Embodiments provide for the macro controller (e.g., optimization module) and the low-level controllers to work together (e.g., having a two-way data flow), in a secure fashion. In one or more embodiments, the macro controller may determine the settings to reach a particular objective. The macro controller may then send the settings to the local controller for implementation at the asset. Before implementation, the local controller may analyze the settings against a set of rules to determine whether the asset may physically operate to achieve that setting, and if so, may it be done in a safe manner. If the setting may be implemented, the local controller may execute the changes in the asset to achieve the setting.

The term “installed product” should be understood to include any sort of mechanically operational entity, including, but not limited to, computed tomography (CT) scanners, jet engines, locomotives, gas turbines, medical equipment and wind turbines at wind farms and their auxiliary systems as incorporated. The term is most usefully applied to large complex systems with many moving parts, numerous sensors and controls installed in the system. The term “installed” includes integration into physical operations such as the engines in an aircraft fleet whose operations are dynamically controlled, a locomotive in connection with railroad operations, turbines in connection with a windfarm, or apparatus construction in, or as part of, an operating plant building, machines in a factory or supply chain and etc.

As used herein, the term “automatically” may refer to, for example, actions that may be performed with little or no human interaction.

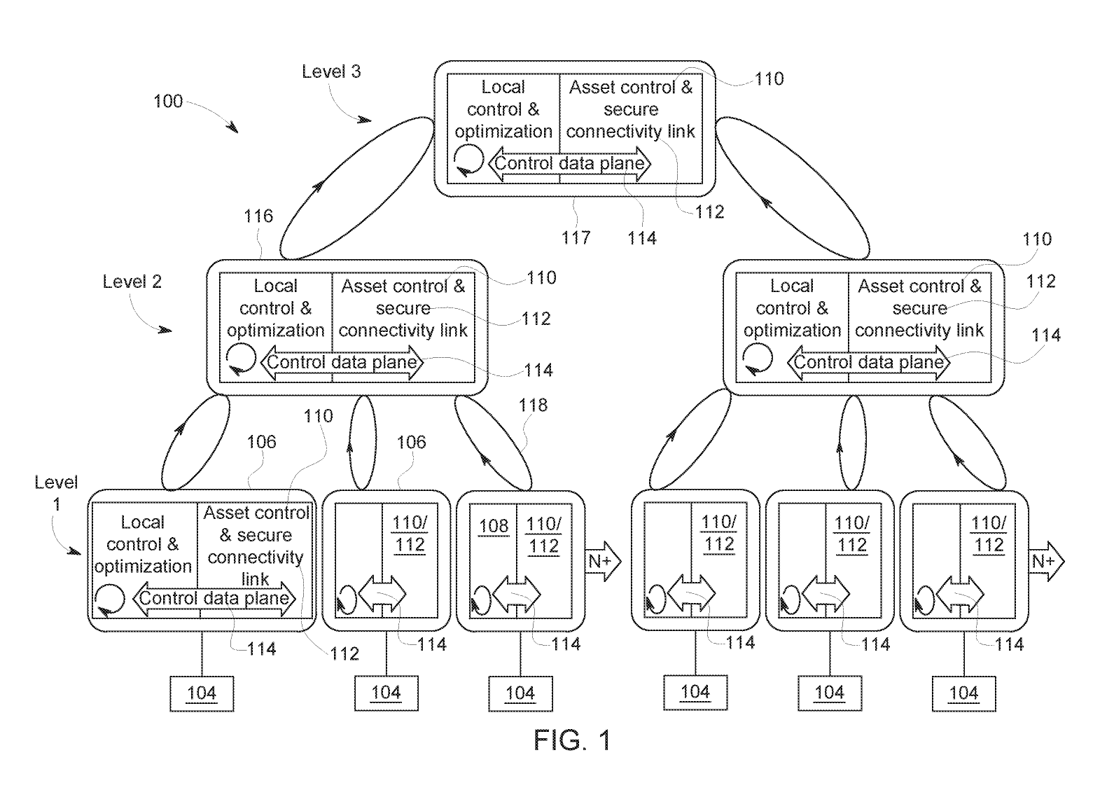

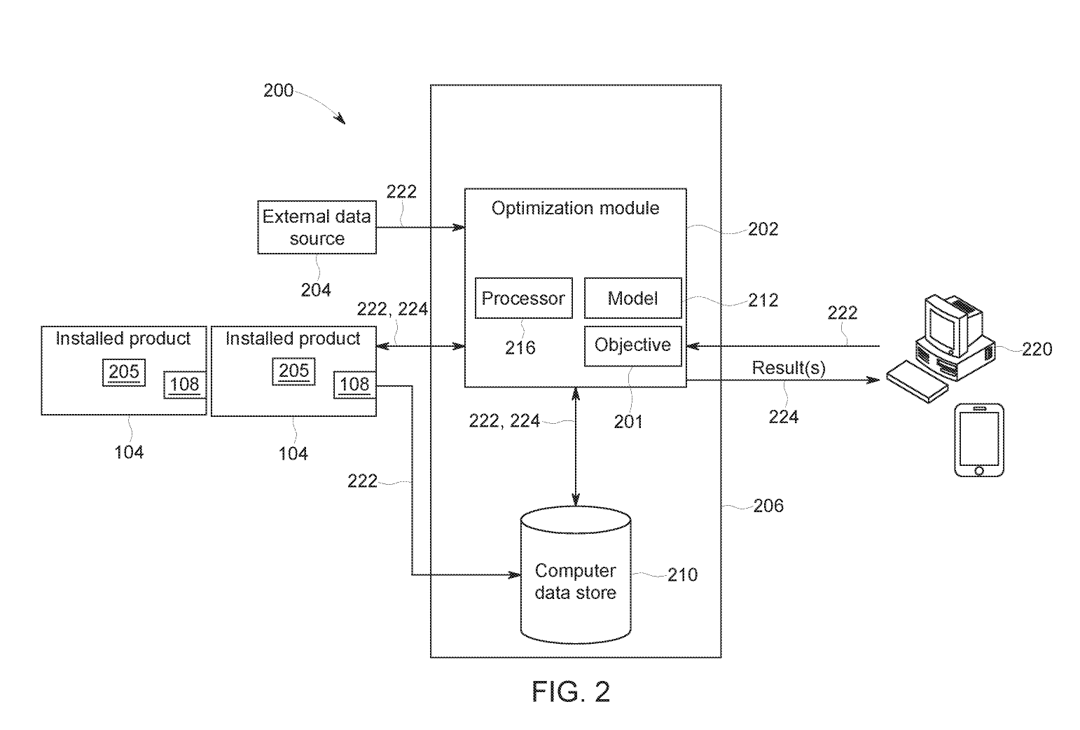

Turning to FIG. 1, a block diagram of an example system 100 in which an optimization module 202 (FIG. 2) may be implemented, is provided, arranged in accordance with at least one embodiment described herein.

The system 100 may include one or more “assets” 104. In one or more embodiments, each asset 104 may be operated by a hierarchy of control levels or layers. For example, Level 1 control 106 may include a local controller 108 on each of the assets 104. Level 1 control 106 may control the individual functions/assets. In one or more embodiments, the local controller 108 may provide instructions to operate the asset 104 via an asset control 110 and a secure connectivity link 112. In one or more embodiments, the asset control 110 may control access points of the local controller 108 from an upper level control (e.g., Level 2, Level 3 . . . Level n). In one or more embodiments, the secure connectivity link 112 may be a conduit that provides trusted communications between different levels. In one or more embodiments, a control data plane 114 may be a mechanism to exchange data between the asset 104 and the local controller 108. The control data plane 114 may validate exchanges and protect the local controller 108 from harmful interactions (e.g., when the locomotive speed is set to violate a speed limit; a turbine is set to operate at a point that may cause a catastrophic overspeed). In one or more embodiments, the Level 1 control 106 may be repeated for each asset 104.

The system 100 may also include a Level 2 control 116. In one or more embodiments, the Level 2 control 116 may be the control of a collection of assets 104 and/or functions. In one or more embodiments, the Level 2 control 116 may be for a plant, for example, and then a Level 3 control 117 may include a network or collection of plants, etc. One or more embodiments provide for the level of control to be scalable as needed. It is noted that the hierarchical structure may expand (or contract) both vertically (e.g., multiple control levels) and horizontally (e.g., multiple assets, collections of assets, plants, networks etc.), as needed.

In one or more embodiments, communication 118 between the different levels may be bi-directional. For example, while the upper levels may provide instructions to the lower levels, the lower levels may communicate data up to the higher levels, so that the data may be aggregated and analyzed, for example. In one or more embodiments, the aggregated data may be used by the system 100 to operate the system towards a particular objective, without a human being involved. For example, if one turbine is out of service, the higher level may re-distribute settings to the operational turbines to re-balance operations of the system to achieve the objective, without a human being involved.

Turning to FIG. 2, a block diagram of an example operating environment or system 200 in which an optimization module 202 may be implemented, arranged in accordance with at least one embodiment described herein is provided. FIG. 2 represents a logical architecture for describing processes according to some embodiments, and actual implementations may include more or different components arranged in other manners.

As described above, the system 200 may include one or more “assets” 104. While two assets 104 are shown herein to represent a fleet of assets, any suitable number may be used. It is noted that each asset 104 communicates with a platform 206, and elements thereof, in a same manner, as described below. As noted above, the asset 104 may be, in various embodiments, a complex mechanical entity, the production line of a factory, a gas-fired electrical generating plant, a jet engine on an aircraft amongst a fleet (two or more assets), a wind farm including a fleet of turbines, a locomotive, etc. As used herein, the terms “installed product” and “asset” may be used interchangeably. The asset 104 may include a considerable (or even very large) number of physical elements or components 205, which for example, may include turbine blades, fasteners, rotors, bearings, support members, housings, etc. As used herein, the terms “physical element” and “component” may be used interchangeably. The asset 104 may also include subsystems, such as sensing and localized control, in one or more embodiments.

In some embodiments, the platform 206 may include a computer data store 210 that may provide information to the optimization module 202 and store results from the optimization module 202. The optimization module 202 may include a model 212, one or more processing elements 216, and an operational objective 201 (“objective”). As described further below, the model 212 may be received from a design platform (not shown), and the objective 201 may be received from an end user (not shown).

The processor 216 may, for example, be a conventional microprocessor, and may operate to control the overall functioning of the optimization module 202. In one or more embodiments, the processor 216 may be programmed with a continuous or logistical model of industrial processes that are used by the one or more assets 104.

In one or more embodiments, the data store 210 may comprise any combination of one or more of a hard disk drive, RAM (random access memory), ROM (read only memory), flash memory, etc. The data store 210 may store software that programs the processor 216 and the optimization module 202 to perform functionality as described herein.

The data store 210 may support multi-tenancy to separately support multiple unrelated clients by providing multiple logical database systems which are programmatically isolated from one another.

The data stored in data store 210 may be received from disparate hardware and software systems associated with the asset 104, or otherwise, some of which may not be inter-operational with one another. The systems may comprise a back-end data environment employed in a business, industrial, or personal context. The data may be pushed to the data store 210 and/or provided in response to queries received therefrom.

In one or more embodiments, the optimization module 202 may receive data from an external data source 204. The external data source 204 may be a data source that provides data outside of the asset's control. For example, the national oceanic and atmospheric administration for weather information, wind data from a local Light Detection and Ranging (LIDAR) sensor, rail network status from Rail Co. Dispatch center, Federal Aviation Administration (FAA) flight traffic data, etc.).

The data from each of the data store 210 and external data source 204, may be included in a relational database, a multi-dimensional database, an eXtendable Markup Language (XML) document, and/or any other structured data storage system. The data from external data source 204 may be included in any other suitable data storage system. The physical tables of data store 210, and external data source 204 (if used) may be distributed among several relational databases, multi-dimensional databases, and/or other data sources. The data of data store 210 and external data source 204 may be indexed and/or selectively replicated in an index.

The data store 210, and external data source 204, may implement an “in-memory” database, in which volatile (e.g., non-disk-based) storage (e.g., Random Access Memory) is used both for cache memory and for storing data during operation, and persistent storage (e.g., one or more fixed disks) is used for offline persistency of data and for maintenance of database snapshots. Alternatively, volatile storage may be used as cache memory for storing recently-used database data, while persistent storage stores data. In some embodiments, the data comprises one or more of conventional tabular data, row-based data stored in row format, column-based data stored in columnar format, and object-based data.

The optimization module 202, according to some embodiments, may access the data store 210 and/or one or more external data sources 204 and utilize the processing elements 216 to execute the model 212. When executed, the model 212 may output results that may be transmitted to (and in some instances presented on) at least one of various user platforms 220 or to other systems (not shown), as appropriate (e.g., for display to, and manipulation by, a user). In one or more embodiments, the results of the model 212 may be used to operate the asset, operate another system, or be input to another system. In one or more embodiments, the output results of the model 212 may directly operate the asset 104 or other system without further human interaction.

A communication channel 222 may be included in the system 200 to supply data from at least one of the asset 104, the data store 210 and external data sources 204 to the optimization module 202.

In some embodiments, the system 200 may also include a communication channel 224 to supply output from the optimization module 202 to at least one of user platforms 220, or to other systems. In some embodiments, signals received by the user platform 220, may cause modification in the state or condition or another attribute of the asset 104.

As used herein, devices, including those associated with the system 200 and any other devices described herein, may exchange information and transfer data (“communication”) via any number of different systems, including one or more wide area networks (WANs) and/or local area networks (LANs) that enable devices in the system to communicate with each other. In some embodiments, communication may be via the Internet, including a global internetwork formed by logical and physical connections between multiple WANs and/or LANs. Alternately, or additionally, communication may be via one or more telephone networks, cellular networks, a fiber-optic network, a satellite network, an infrared network, a radio frequency network, any other type of network that may be used to transmit information between devices, and/or one or more wired and/or wireless networks such as, but not limited to Bluetooth access points, wireless access points, IP-based networks, or the like. Communication may also be via servers that enable one type of network to interface with another type of network. Moreover, communication between any of the depicted devices may proceed over any one or more currently or hereafter-known transmission protocols, such as Asynchronous Transfer Mode (ATM), Internet Protocol (IP), Hypertext Transfer Protocol (HTTP) and Wireless Application Protocol (WAP).

A user may access the system 200 via one of the user platforms 220 (a control system, a desktop computer, a laptop computer, a personal digital assistant, a tablet, a smartphone, etc.) to access the optimization module 202 and information about and/or manage the asset 104 in accordance with any of the embodiments described herein. According to one or more embodiments, the system 200 may execute program code of a software application for presenting interactive graphical user display interfaces to allow interaction with the optimization module 202.

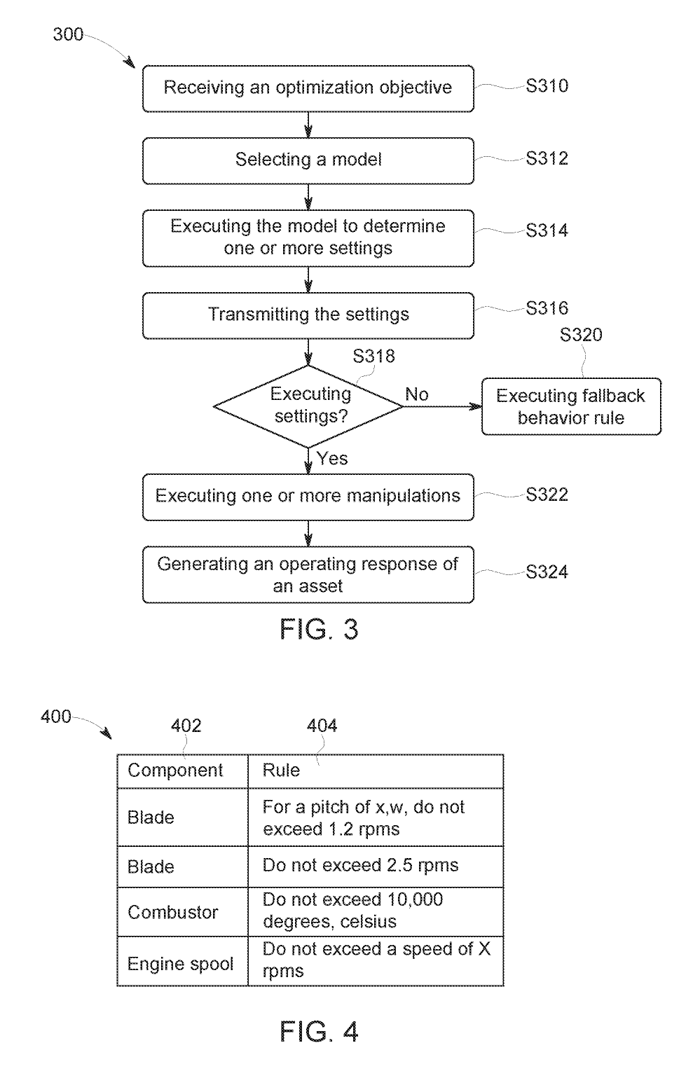

Turning to FIG. 3, a flow diagram of an example of operation according to some embodiments is provided. In particular, FIG. 3 provides a flow diagram of a process 300, according to some embodiments. Process 300, and any other process described herein, may be performed using any suitable combination of hardware (e.g., circuit(s)), software or manual means. For example, a computer-readable storage medium may store thereon instructions that when executed by a machine result in performance according to any of the embodiments described herein. In one or more embodiments, the system 200 is conditioned to perform the process 300 such that the system is a special-purpose element configured to perform operations not performable by a general-purpose computer or device. Software embodying these processes may be stored by any non-transitory tangible medium including a fixed disk, a floppy disk, a CD, a DVD, a Flash drive, or a magnetic tape. Examples of these processes will be described below with respect to embodiments of the system, but embodiments are not limited thereto. The flow chart(s) described herein do not imply a fixed order to the steps, and embodiments of the present invention may be practiced in any order that is practicable.

Prior to beginning the process 300, a developer in a design environment (not shown) may create one or more optimization models 212 for execution by the optimization module 202. For example, a model 212 may determine wind turbine settings to optimize an electricity output of a windfarm. In one or more embodiments, inputs to the model 212 may include data from the local controller 108 (e.g., variables, communication interfaces, metadata, etc.) as provided by the asset 104 itself, and data from the external data sources 204. In one or more embodiments, the metadata from the local controller 108 may represent data from the actual asset (e.g., sensor data, settings, feedback on suggested settings, etc.) In one or more embodiments, the developer may use one or more actual control variables for the particular asset 104 in the model 212, instead of using a generic feature as a placeholder. Conventionally, a developer designs a model with a generic placeholder (e.g., wind speed), and then just prior to execution of the model 212, the actual variables of the given asset are physically/manually linked to the placeholder. One or more embodiments provide for the developer to output a model 212 that is linked to the asset's control variables and does not require a manual mapping of the control variables. Of note, embodiments provide a model that may be pre-tailored to the asset itself, and the metadata that is input to the model may be specific to the asset 104, as compared to a typical model that uses generic placeholder variables. The inventors note that since the model 212 uses actual control variables, when the model is deployed or executed, the typical extra step of manually mapping different variables for the asset to the placeholder variables in the model is avoided.

Initially at S310, an optimization objective 201 is received at the optimization module 202. In one or more embodiments, the optimization objective 201 may be received from the user platform 220, or any other suitable source. In one or more embodiments, the user platform 220 may be associated with any of the levels 114, 116, 117.

Then in S312, the optimization module 202 may select an appropriate model 212 to execute to determine one or more appropriate settings for operation of each of the one or more assets 104 to achieve the optimization objective 201. In one or more embodiments, the model may be selected based on the asset and the aspect being optimized. The model may represent the device and its capabilities, and the model may be driven by particular asset and the operational constraints of the asset. Execution of the model may result in the determination of appropriate settings. The model 212 may be executed in S314. In one or more embodiments, the model 212 may be executed using external data 204 in addition to the individual asset data from the one or more assets 204.

Next, the determined setting(s) are transmitted to the local controller 108 at each of the assets 104 via a suitable communication interface in S316. For example, the communication interface may include Ethernet, Wi-Fi, cellular. Any other suitable secure communication interface may be used.

The local controller 108 then determines whether the received settings may be executed in S318. In one or more embodiments, the optimization module 202 may determine which variables the local controller 108 may manipulate to produce the setting, and may suggest those variables to the local controller 108. Then the local controller 108 may analyze the received settings with respect to those variables to determine whether a change to the variable may be implemented. In one or more embodiments, the received settings may be analyzed with respect to rules regarding asset capability, operability, and domain knowledge (e.g., data indicating the typical operability for this type of asset) as well as safety. In one or more embodiments, the local controller 108 may compare the one or more generated operational settings to the capability and domain knowledge to determine whether the variable may be implemented. For example, FIG. 4 provides a rules table 400 that indicates for an asset component 402, one or more rules 404.

As a non-exhaustive example, the local controller 108 may receive a set point output of 1.3 for its respective wind turbine asset 104. Then the local controller 108 may determine that it may manipulate a blade speed (e.g., variable) of the turbine 104 to achieve the received setting. Next the local controller 108 analyzes the rules table 400 to determine whether the blade may be manipulated at such a speed to achieve the setting.

When the local controller 108 determines the received setting cannot be executed in S318, the process 300 may proceed to S320. Continuing with the non-exhaustive turbine example from above, analysis of the rules table 400 may indicate that the blade 205 is positioned at such a pitch that when rotated at a speed to achieve the setting, the blade 205 will rip apart. In S320, the local controller 108 may not execute the variable changes and instead may execute a fallback behavior rule. In one or more embodiments, the fallback behavior rule may depend on the asset itself. For example, the fallback behavior rule may be for the asset 104: continue operation as before the local controller received the set point; or cease operation (e.g., the asset did not get the setting it needed to continue operation). In one or more embodiments, the local controller 108 may determine whether the received setting may be implemented by manipulating another variable.

In one or more embodiments, the determination of the local controller 108 may be transmitted to the user platform 220. In response to the determination of the local controller 108, the end user may, in one or more embodiments, change the objective 201.

When the local controller 108 determines the received setting can be executed in S318, the process 300 may proceed to S322 and the manipulations are executed by the local controller to achieve the received settings.

Then in S324, an operating response of the asset 104 is generated in response to the received manipulations. In one or more embodiments, the asset operation may generate data (e.g., asset health and manipulated variable feedback) that may be stored in the computer data store 210, and/or may be used by the end user to change the objective 201. In one or more embodiments, the data may indicate the objective 201 is being achieved.

While the embodiments herein are described with respect to a single objective, the system 200 may include more than one objective 201. For example, one objective may be to have an equipment life that lasts a long time, while another objective may be to have the asset produce a particular amount. In one or more embodiments, the individual objectives (e.g., equipment life, output, etc.) may be combined to a larger aggregate objective 201 that may balance the individual objectives.

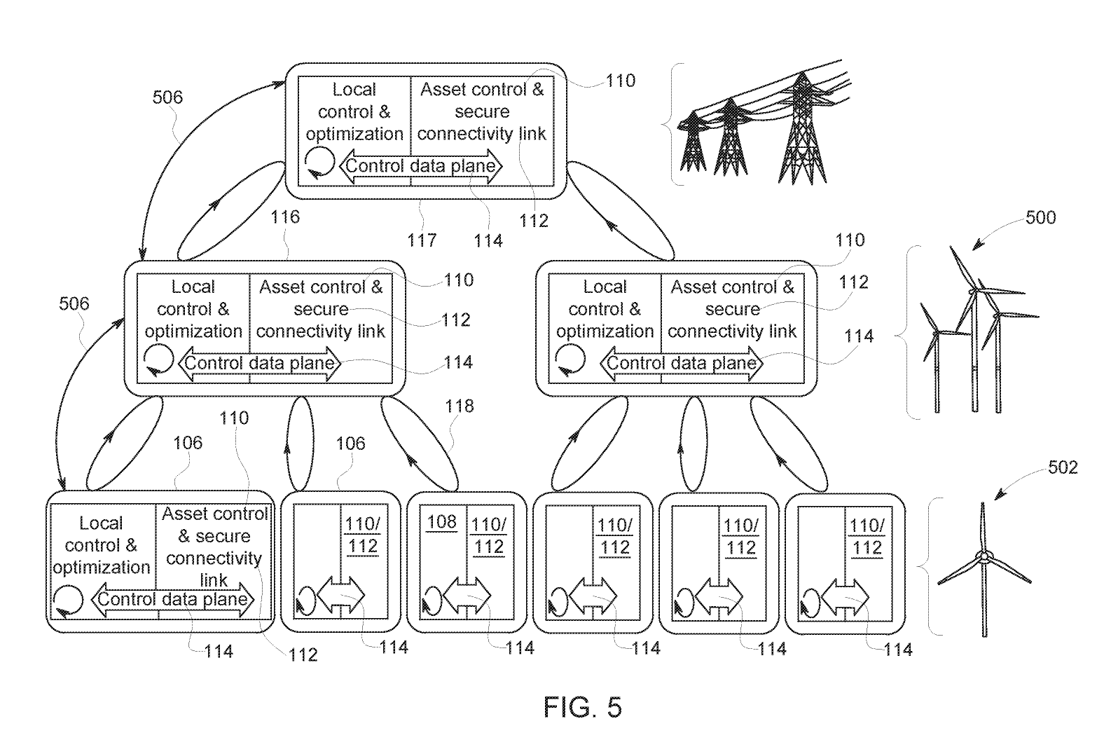

Turning to FIG. 5, a non-exhaustive example of a windfarm 500 is provided and described with respect to one or more embodiments. A windfarm 500 may typically include hundreds of turbines 502. The Level 3 control 117 may be concerned with controlling and optimizing a power grid network for stability and maximizing renewables based generation; the Level 2 control 116 may be concerned with controlling and optimizing an entire wind farm for farm level output power generation; and the Level 1 control 114 may be concerned with controlling and optimizing individual wind turbines 502 via a local controller 504 for performance and safe operation (e.g., given a set point, output as many megawatts as possible). As an example, from a Level 3 perspective, it may be undesirable to receive too much power on the grid, so to optimize the power network, Level 3 may instruct one windfarm to produce less. As another example, from a Level 2 windfarm perspective, embodiments may execute the optimization module 202 to optimize the output of the windfarm, as opposed to the individual turbines. For example, Turbine1 may be upstream of Turbine2 and Turbine3, and may rob Turbine2 and Turbine3 of wind flow and therefore energy production. In one or more embodiments, for example, per the optimization module 202, an outcome optimizer loop 506 may determine that when Turbine1 is operated at a slower pace, less wake may be created, which may allow Turbine2 and Turbine3 to run more optimally. The optimization module 202 may send the set point for Turbine1 to the local controller 504, and may suggest the that Turbine1 may be slowed by applying break forces. The local controller 504 may determine whether applying the break forces satisfies the rules. Of note, the set point determined by the optimization module 202 may cause an individual asset 502 to operate sub-optimally, but may allow the output of the system to achieve the objective 201. In one or more embodiments, the outcome optimizer loop 506 may transmit the information back to the Level 3 control 117, and an optimization module 202 at the Level 3 control 117 may take further actions.

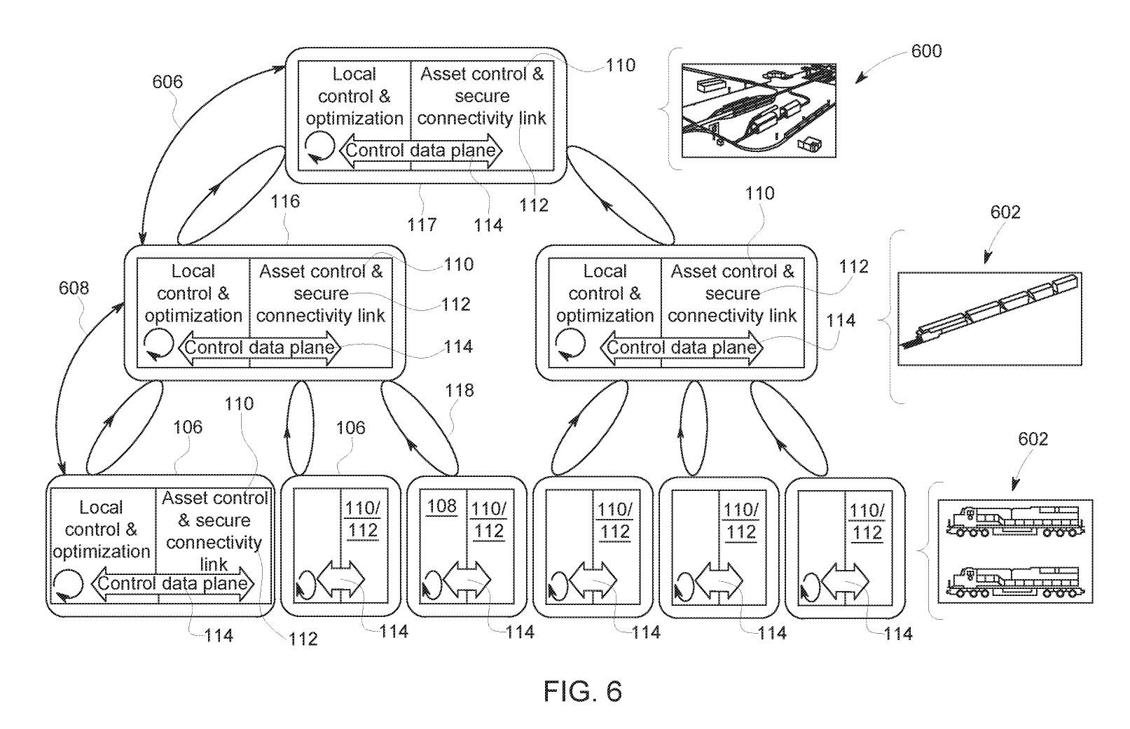

Turning to FIG. 6, a non-exhaustive example of a transportation network 600 is provided and described with respect to one or more embodiments. A transportation network 600 may typically include multiple locomotives 602. The Level 3 control 117 may be concerned with controlling and optimizing performance, fuel efficiency and maximum network velocity; the Level 2 control 116 may be concerned with controlling and optimizing an entire train for performance, fuel efficiency and in-train forces; and the Level 1 control 114 may be concerned with controlling and optimizing individual locomotives 602 via a local controller 604 for performance and fuel efficiency. Similar to the turbine example above, each locomotive trying to optimize itself may not be best for the objective of maintaining a functioning train (e.g., two locomotives and one or more cars in between them). If, for example, Locomotive1 is on the downside of a hill and Locomotive2 is on the upside, when both locomotives are trying to be most efficient, Locomotive1 is pulling cars apart and Locomotive2 is pushing them together. This pushing/pulling must stress on the cars (in-train forces) and the result may be broken asset components. As such, from a Level 3 transportation network perspective, embodiments may execute the optimization module 202 to optimize the network, as opposed to the individual locomotives. In one or more embodiments, for example, per the optimization module 202 at the Level 3 control 117, an outcome optimizer 606 may command each locomotive to run slower to reduce hitting choke points, thereby improving average speed of all trains. Additionally, and in some embodiments simultaneously or substantially simultaneously, the optimization module 202 at the Level 2 control 116 may command each locomotive 602 to run less optimally from an individual view to reduce stresses across the locomotive via another outcome optimizer 608.

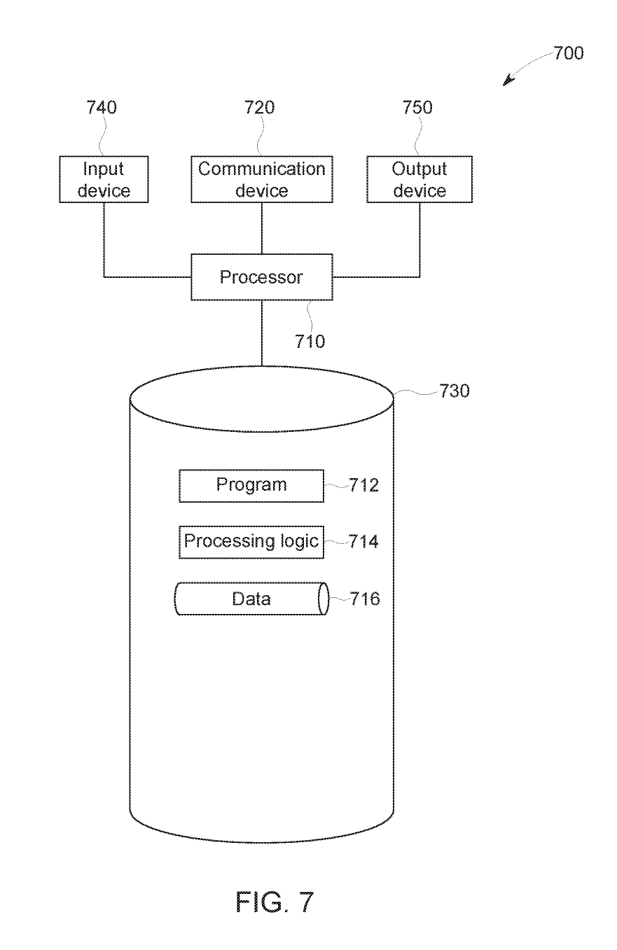

Note the embodiments described herein may be implemented using any number of different hardware configurations. For example, FIG. 7 illustrates an optimization platform 700 that may be, for example, associated with the systems described herein (e.g., system 100 of FIG. 1 and/or system 200 of FIG. 2). The optimization platform 700 comprises an optimization processor 710 (“processor”), such as one or more commercially available Central Processing Units (CPUs) in the form of one-chip microprocessors, coupled to a communication device 720 configured to communicate via a communication network (not shown in FIG. 7). The communication device 720 may be used to communicate, for example, with one or more users. The optimization platform 700 further includes an input device 740 (e.g., a mouse and/or keyboard to enter information) and an output device 750 (e.g., to output and display the manipulations).

The processor 710 also communicates with a memory/storage device 730. The storage device 730 may comprise any appropriate information storage device, including combinations of magnetic storage devices (e.g., a hard disk drive), optical storage devices, mobile telephones, and/or semiconductor memory devices. The storage device 730 may store a program 712 and/or optimization processing logic 714 for controlling the processor 710. The processor 710 performs instructions of the programs 712, 714, and thereby operates in accordance with any of the embodiments described herein. For example, the processor 710 may receive data and then may apply the instructions of the programs 712, 714 to determine settings for an asset to achieve an objective.

The programs 712, 714 may be stored in a compressed, uncompiled and/or encrypted format. The programs 712, 714 may furthermore include other program elements, such as an operating system, a database management system, and/or device drivers used by the processor 710 to interface with peripheral devices.

As used herein, information may be “received” by or “transmitted” to, for example: (i) the platform 700 from another device; or (ii) a software application or module within the platform 700 from another software application, module, or any other source.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams and/or described herein. The method steps can then be carried out using the distinct software modules and/or sub-modules of the system, as described above, executing on one or more hardware processors 710 (FIG. 7). Further, a computer program product can include a computer-readable storage medium with code adapted to be implemented to carry out one or more method steps described herein, including the provision of the system with the distinct software modules.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application.

Those in the art will appreciate that various adaptations and modifications of the above-described embodiments can be configured without departing from the scope and spirit of the claims. Therefore, it is to be understood that the claims may be practiced other than as specifically described herein.

1. A computer-implemented method comprising:
receiving an operational objective for one or more assets at an optimizer module;
generating, via the optimization module, one or more operational settings to apply to the one or more assets based on the received operational objective;
receiving the one or more generated operational settings at a local controller for each of the one or more assets; and
generating an operating response of the one or more assets to achieve the one or more generated operational settings.

2. The method of claim 1, further comprising:
determining the one or more generated operational settings received at the local controller are valid for each of the one or more assets.

3. The method of claim 2, wherein determining the one or more generated operational settings is valid further comprises:
determining a capability for each asset;
determining a domain knowledge associated with the one or more assets;
comparing the one or more generated operational settings to the determined capability and the determined domain knowledge.

4. The method of claim 1, further comprising:
generating feedback based on execution of the one or more assets; and
communicating the feedback to the optimization module.

5. The method of claim 1, further comprising:
receiving, at the optimization module, external data prior to generating the one or more operational settings; and
generating the one or more operational settings based on the received external data.

6. The method of claim 1, wherein generating the one or more operational settings further comprises:
receiving a model at the optimization module; and
executing the model at the optimization module.

7. The method of claim 6, wherein the model is received from an optimizer design environment.

8. the method of claim 6, wherein the model includes one or more control variables from the asset.

9. A system comprising:
one or more assets;
a computer programmed with an optimization module for the asset, the optimization module for controlling operations of the one or more assets with respect to an operational objective;
the computer including a processor and a memory in communication with the processor, the memory storing the optimizer module and additional program instructions, wherein the processor is operative with the optimization module and additional program instructions to perform functions as follows:
receiving the operational objective for the one or more assets at the optimization module;
generating, via the optimization module, one or more operational settings to apply to the one or more assets based on the received operational objective;
receiving the one or more generated operational settings at a local controller for each of the one or more assets; and
generating an operating response of the one or more assets to achieve the one or more generated operational settings.

10. The system of claim 9, wherein the operating response is generated in response to execution of the generated operational settings at each of the one or more assets.

11. The system of claim 9, further comprising additional program instructions to perform functions as follows:
determining the one or more generated operational settings received at the local controller are valid for each of the one or more assets.

12. The system of claim 11, wherein determining the one or more generated operational settings is valid further comprises additional program instructions to perform functions as follows:
determining a capability for each asset;
determining a domain knowledge associated with the one or more assets;
comparing the one or more generated operational settings to the determined capability and the determined domain knowledge.

13. The system of claim 9, further comprising additional program instructions to perform functions as follows:
generating feedback based on execution of the one or more assets; and
communicating the feedback to the optimization module.

14. The system of claim 9, wherein the operational settings are generated based on external data received at the optimization module prior to generating the one or more operational settings.

15. The system of claim 9, wherein generating the one or more operational settings further comprises additional program instructions to perform functions as follows:
receiving a model at the optimization module; and
executing the model at the optimization module.

16. The system of claim 15, wherein the model includes one or more control variables from the asset.

17. A non-transitory, computer-readable medium storing instructions that, when executed by a computer processor, cause the computer processor to perform a method comprising:
receiving the operational objective for one or more assets at an optimization module;
generating, via the optimization module, one or more operational settings to apply to the one or more assets based on the received operational objective;
receiving the one or more generated operational settings at a local controller for each of the one or more assets; and
generating an operating response of the one or more assets to achieve the one or more generated operational settings.

18. The medium of claim 17, wherein the operating response is generated in response to execution of the generated operational settings at each of the one or more assets.

19. The medium of claim 17, further comprising additional program instructions to perform functions as follows:
determining the one or more generated operational settings received at the local controller are valid for each of the one or more assets.

20. The medium of claim 19, wherein determining the one or more generated operational settings is valid further comprises additional program instructions to perform functions as follows:
determining a capability for each asset;
determining a domain knowledge associated with the one or more assets; and
comparing the one or more generated operational settings to the determined capability and the determined domain knowledge.

21. The medium of claim 17, further comprising additional program instructions to perform functions as follows:
generating feedback based on execution of the one or more assets; and
communicating the feedback to the optimization module.

22. The medium of claim 17, wherein the operational settings are generated based on external data received at the optimization module prior to generating the one or more operational settings.

23. The medium of claim 17, wherein generating the one or more operational settings further comprises:
receiving a model at the optimization module; and
executing the model at the optimization module.

24. The medium of claim 23, wherein the model includes one or more control variables from the asset.
